(19) United States
(12) Patent Application Publication
(10) Pub. No.: US 2003/0139933 A1
(43) Pub. Date: Jul. 24, 2003

(54) Use of local voice input and remote voice processing to control a local visual display

(76) Inventor: Zebadiah Kimmel, Chicago, IL (US)

Correspondence Address: Zebadiah Kimmel, 512 N. McClurg Ct. #605, Chicago, IL, 60611, US

(21) Appl. No.: 10/348,262

(22) Filed: Jan. 21, 2003

Related U.S. Application Data
(60) Provisional application No. 60/350,891, filed on Jan. 22, 2002.

(51) Int. Cl. G10L 21/00

(52) U.S. Cl. 704/275

(57) ABSTRACT

A user uses voice commands to modify the contents of a visual display through an audio input device where the audio input device does not necessarily have speech recognition capabilities. The audio input device, such as a telephone, captures audio including spoken voice commands from a user and transmits the audio to a remote system. The remote system is configured to use automated speech recognition to recognize the voice commands. The recognized commands are interpreted by the remote system to respond to the user by transmitting data to be displayed on the visual display. The visual display can be integrated with the audio input device, such as in a web-enabled mobile phone, a video phone or an internet video phone, or the visual display can be separate, such as on a television or a computer display.

### PRIORITY INFORMATION

This application claims the benefit of U.S. Provisional Application No. 60/350,891, filed on Jan. 22, 2002.

### BACKGROUND OF THE INVENTION

1. Field of the Invention

The invention relates generally to uses of automated speech recognition technology, and more particularly, the invention relates to the remote processing of locally captured speech to control a local visual display.

2. Description of the Related Art

A variety of electronic devices are available that are capable of both visual output (e.g. to an LCD screen) and sound input (e.g. from a phone headset or microphone). Such devices (referred to herein as SIVOs) range from computationally powerful desktop computers to computationally weaker personal digital assistants (PDAs) and screen-equipped telephones. The additional capabilities of either sound output or video input are optional in a SIVO. Typical SIVO devices include, for example, handheld PDAs manufactured by Palm, Compaq, Handspring, and Sony; screen-equipped telephones manufactured by Cisco and PingTel; and screen-equipped or web-enabled mobile phones manufactured by Nokia, Motorola and Ericsson.

### SUMMARY OF THE INVENTION

For many or all SIVO devices, it is desirable to use human speech to control the visual display of the device. Here are some examples of using human speech to control the visual display of a SIVO device:

“Show me all plane flights from LaGuardia to Chicago next Tuesday.”->The screen displays a list of airline flights fitting the desired criteria.

“Email Jane the document titled ‘finances.xsl”.”->The screen displays a confirmation that the document has been emailed.

“What is the meaning of the word spelled I-N-V-E-N-T-I-V-E?”->The screen displays the appropriate dictionary definition.

“Where am I?”->The screen displays a Global Positioning System-derived map showing the device's current location.

“Get me a reservation at a local Chinese restaurant.”->The screen displays the reservation time and place.

It may be seen from the examples above that as a result of voice processing, additional actions (such as emailing a document or making a restaurant reservation) in addition to changing the visual display of the device may optionally occur.

Although speech recognition (also referred to as “voice recognition”) systems that possess adequate recognition and accuracy rates for many applications are now available, such speech recognition systems require computationally powerful machines on which to run. As a rule-of-thumb, such machines have processor power and speech equivalent to at least a 1-GHz Intel Pentium-class processor and 256 MB of RAM. A device that processes speech will be referred to herein as a SPRO device; one example of a SPRO device is a 1 GHZ Windows 2000 desktop computer running speech recognition software made by Nuance Communications.

Although it is desirable to use human speech (voice) to control computationally constrained SIVO devices in such a way as to manipulate the information these devices present on their screen, their computational weakness means that it is not possible to operate a speech recognition system on such devices. It is therefore desirable to enable the SIVO to utilize the services of a separate SPRO, in the following fashion:

The SIVO receives local voice input from a user.

The SIVO sends the voice input to a SPRO for speech processing.

The SPRO processes the speech and sends instructions for updating the visual display back to the SIVO.

The SIVO updates its screen according to the instructions.

Even if future SIVO devices are powerful enough to operate on-board speech recognition systems, it may be desirable to offload such speech recognition onto a separate SPRO for any of the following reasons:

It is easier to administer and upgrade a single central SPRO than a large number of mobile SIVOs-for example, to update dictionaries or add dialects.

It is easier to handle authentication and security (e.g. voiceprints) through a central SPRO than a large number of mobile SIVOs.

Speech recognition is computationally expensive and may weigh heavily on the resources of a SIVO, even a computationally powerful one.

Speech recognition may add significant expense to a SIVO.

In accordance with one embodiment, voice input is received by a SIVO, passed to a SPRO for processing, and ultimately used to delineate and control changes to the SIVO's visual display. In accordance with one embodiment voice input on one device is used to influence the visual display on a separate device, in which case the devices need not be SIVO devices.

### BRIEF DESCRIPTION OF THE DRAWINGS

FIG. 1 illustrates an overview of a method in accordance with one embodiment of the invention.

FIG. 2 illustrates one embodiment of a method performed by the SPRO during step 4 of FIG. 1.

FIG. 3 illustrates one embodiment as implemented on currently existing software/hardware platforms.

FIG. 4 illustrates one embodiment that uses a Cisco 7960 voice-over-IP phone.

FIG. 5 illustrates an embodiment wherein the voice input and visual display output are decoupled (implemented on separate devices).

FIG. 6 illustrates an embodiment in which a user speaks into a phone to change the display of information on a television set.

FIG. 7 illustrates an embodiment in accordance with which the invention is used to access a Web Service.

### DETAILED DESCRIPTION OF THE INVENTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices, components, and methods to those described herein. In other instances, well-known devices, components, and methods have not been described in detail so as not to unnecessarily obscure aspects of the present invention.

I. General Embodiment

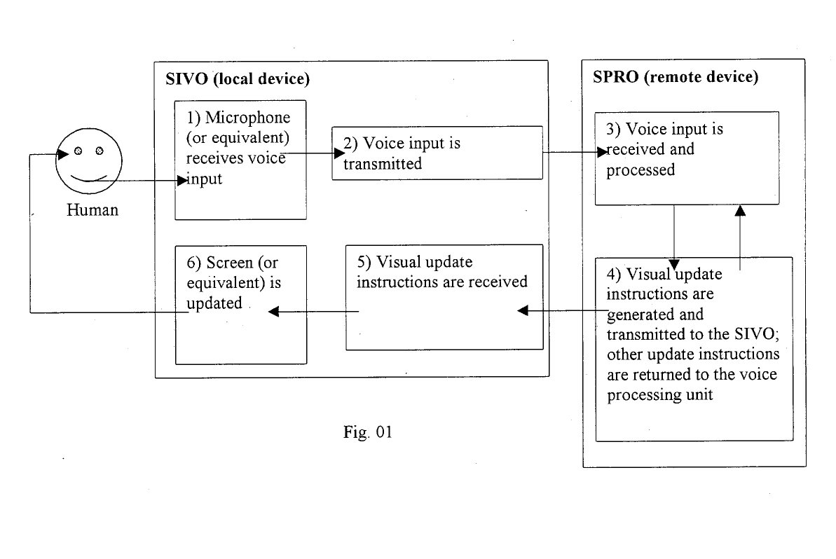

FIG. 1 illustrates an overview of a method in accordance with one embodiment of the invention. Step 1 shows a SIVO device (a device that has at least audio input and visual output) receiving speech from a user: for example, the user may be talking into an on-board microphone, or into a microphone that is plugged into the SIVO.

At a step 2, the audio input (user speech) is sent to a SPRO (a device that performs the actual speech processing). The audio can be transmitted as a sound signal (as if the SPRO were listening on a telephone conversation), or the audio can first be broken down by the SIVO into phonemes (units of speech), so that the SPRO receives a stream of phoneme tokens. So that phoneme identication can be offloaded from the SIVO to the SPRO, transmission of the audio input as a sound signal is preferred. Such sound transmission can be accomplished using single methods (such as analog transmission, or raw audio over a TCP/IP connection or RTP/UDP/IP connection) or a combination of methods (such as transmission over the Public Switched Telephone Network as G.711 PCM followed by transmission over a LAN as RTP/UDP/IP). These various methods of transmission of audio information are common in the telephony industry and familiar to practitioners of the art. The transmission link between the SIVO and the SPRO can be wireless (e.g. 802.11 or GSM), a physical cable (e.g. Ethernet), a network (e.g. the Public Switched Telephone Network or a LAN), or a combination thereof.

At a step 3, the audio input is received by the SPRO and processed. There exist a number of commercial systems that can receive voice input and process it in some fashion. The speech processing module preferably supports VoiceXML, which is a language used to describe and process speech grammars. VoiceXML-compliant speech recognition systems are currently manufactured and/or sold by various companies including Nuance, IBM, TellMe, and BeVocal.

At a step 4, the speech recognition system interfaces with a computer program that takes actions based on the tokens recognized by the speech recognition system. The speech recognition system is responsible for processing audio input and determining which words (tokens) or phrases were spoken. The computer program, however, preferably decides what actions to take once tokens have been matched to speech. In one embodiment, the computer program and speech recognition system can be integrated into a single system or computer program.

There exist a number of commercial systems that can interact with speech recognition systems-for example, based on Java or other computer languages-but the preferred method is to use a web server (or a web application server, or both types of server in combination we will simply use the generic term “web server” to encompass these various possibilities) that serves VoiceXML pages to the speech recognition unit. Web servers that can serve VoiceXML pages include Microsoft IIS, Microsoft ASP NET, Apache Tomcat, IBM WebSphere, and many more. It is within the environment of the web server that application-specific code is written in languages such as XML, C#, and Java.

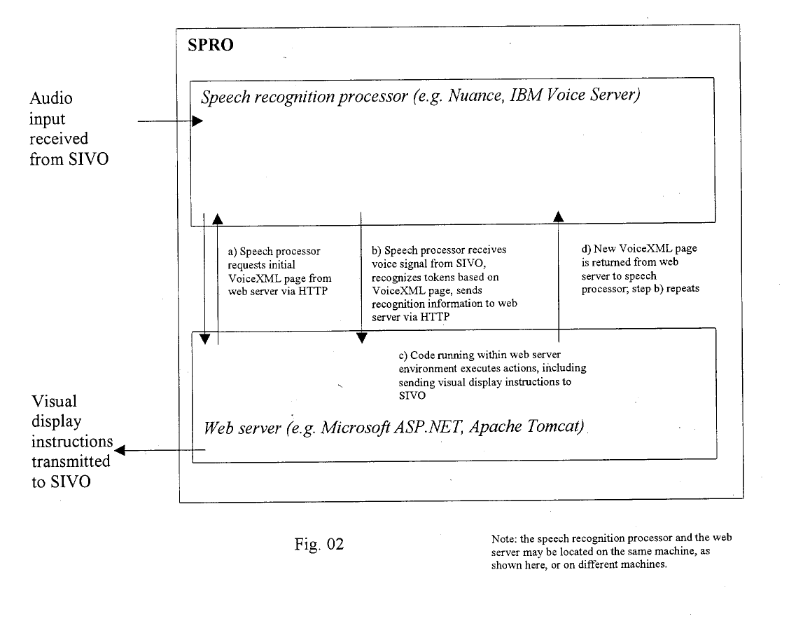

FIG. 2 illustrates one embodiment of a method performed by the SPRO during step 4 of FIG. 1. As illustrated in FIG. 2, the sequence of events in step 4 of FIG. 1 are preferably performed as follows: the web server sends an initial VoiceXML page to the speech recognition unit that describes the types of words and phrases to recognize; the speech recognition unit waits for voice input; as voice input is received, the speech recognition unit sends a list of recognized tokens or phrases to the web server; the web server acts on these tokens in some desired way (for example, sends an email or draws a picture for eventual display on the SIVO); and the web server returns a VoiceXML page back to the speech recognition unit so that the cycle may repeat. The preferred method for communication between the speech recognition unit and the web server is HTTP, but alternate methods (e.g. direct TCP/IP connections) may be used instead.

In FIG. 2 the speech recognition unit and the web server unit are illustrated as residing on the same physical machine. The speech recognition unit and the web server can, however, reside on different pieces of equipment, communicating with each other via HTTP or another communication protocol. In some embodiments, the SPRO can include two or more devices rather than one. Placing the speech recognition processor and the web server on different devices may be desirable because the two units can then be maintained and upgraded independently.

At a step 5 of FIG. 1, visual update instructions are transmitted from the SPRO to the SIVO. As described above, the instructions are preferably visual update instructions generated by the web server software on the SPRO in step c) of FIG. 2. These instructions may consist of HTML, XML, JavaScript, or any other language that can be used by the SIVO to update the SIVO's visual display. These instructions may be sent to the SIVO (“push”) or may be requested periodically or aperiodically by the SIVO (“pull”). The preferred method of transmission of the visual update instructions from the SPRO to the SIVO is HTTP, but other methods (such as a raw TCP/IP stream) may be used.

At a step 6 of FIG. 1, the SIVO uses the visual update instructions received from the SPRO to update the SIVO's visual display.

As illustrated in FIG. 1, the user has spoken into the local (to the user) SIVO device, the user's speech has been sent to the remote SPRO device, and visual update instructions have been sent from the SPRO back to the SIVO. From the user's point of view, the visual display of the SIVO changes (in a desirable way) in response to the user's speech.

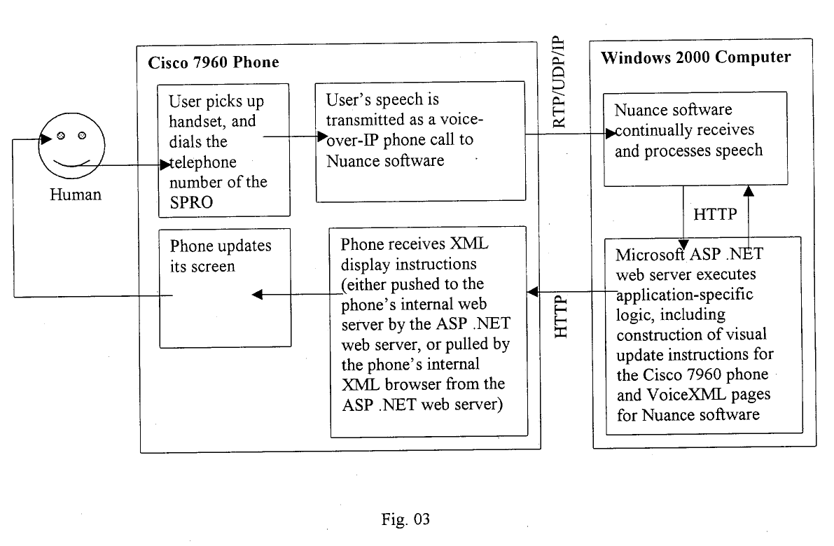

FIG. 3 illustrates one embodiment as implemented on currently existing software/hardware platforms.

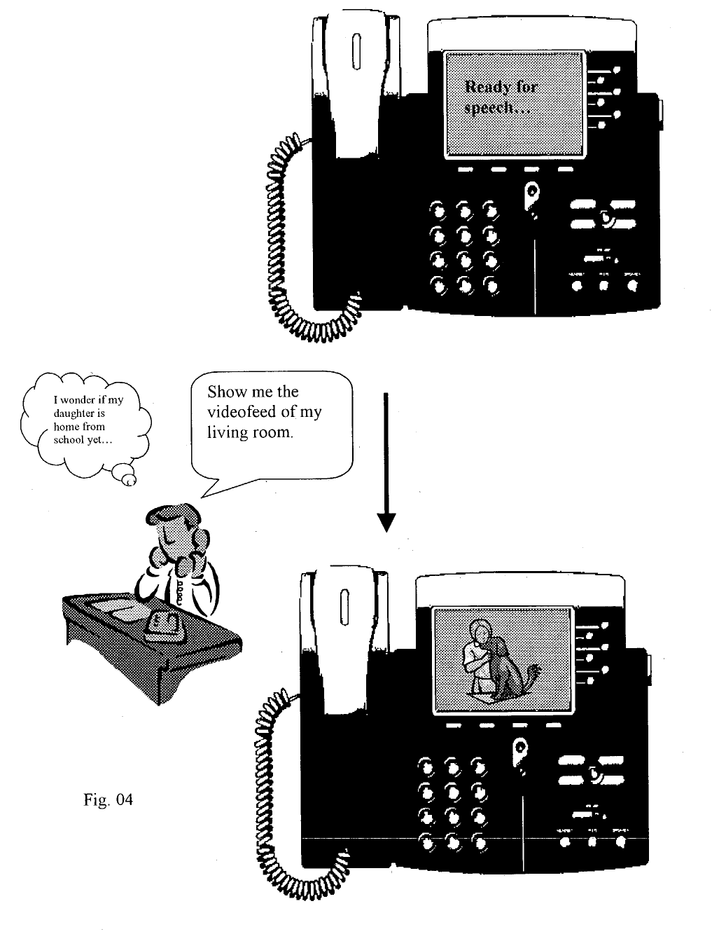

FIG. 4 illustrates one embodiment that uses a Cisco 7960 voice-over-IP phone. In the example shown in FIG. 4, the remote SPRO has access to images from a webcam in the user's living room, e.g. via FTP.

II. Additional Embodiments

A. Use of Two (Possibly Non-SIVO) Devices

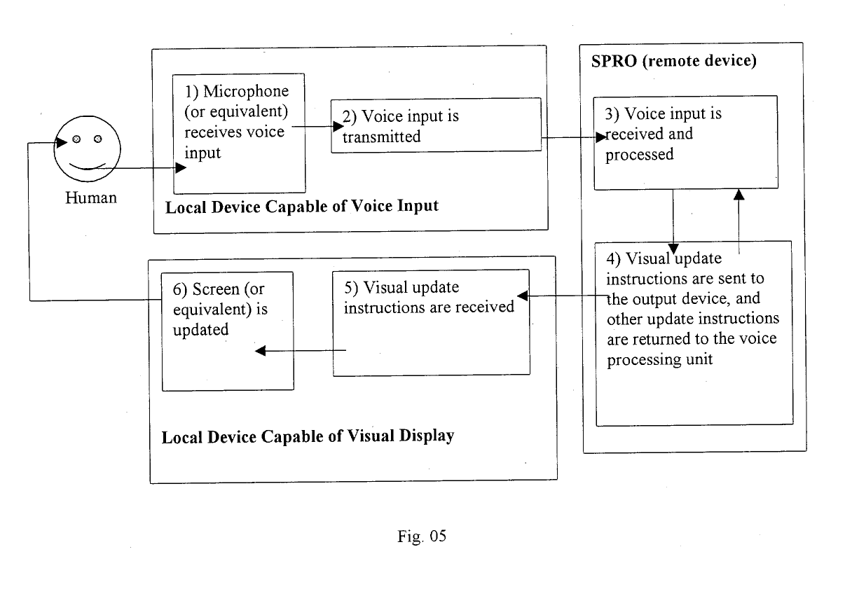

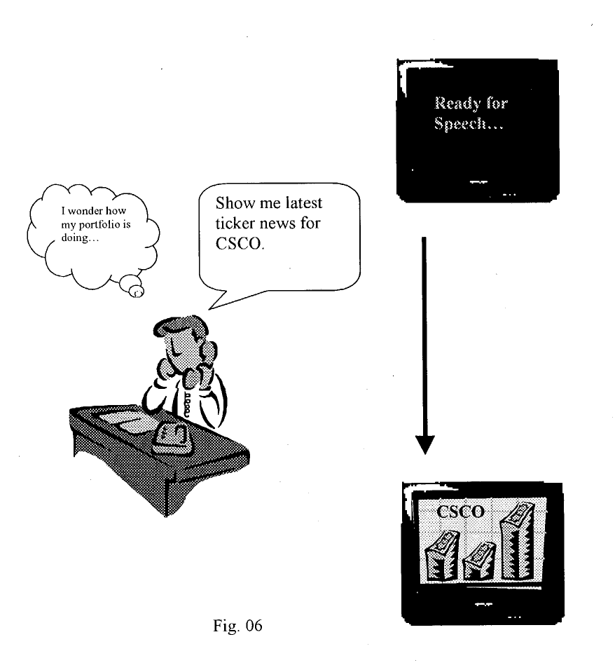

Although the invention has been described in relation to a single SIVO device, the invention can be adapted to handle the situation of two separate (possibly non-SIVO) devices—one device possessing voice input, and one device possessing visual display. FIGS. 5 and 6 illustrate embodiments of the invention involving multiple (possibly non-SIVO) devices.

FIG. 5 illustrates an embodiment wherein the voice input and visual display output are decoupled (implemented on separate devices).

FIG. 6 illustrates an embodiment in which a user speaks into a phone to change the display of information on a television set. The phone acts as the voice input and the TV acts as the display output. In this embodiment, the phone need not have visual display capabilities, and the TV need not have audio input capabilities. The example shown in FIG. 6 can be implemented, for example, using a television display system such as WebTV or AOLTV that receives visual display information from a web server.

B. Use of Multiple Audio Input Devices and/or Multiple Visual Output Devices

In one embodiment, the invention can be used to handle multiple audio inputs. In step 3 of FIG. 1, multiple incoming audio input streams can be combined (“mixed”) into a single audio stream which is then received and processed by the speech recognition unit. Alternatively, the speech recognition unit can receive and handle multiple simultaneous parallel audio input streams, in which case the speech recognition unit preferably deals with each input stream on an individual basis.

In one embodiment, the invention can be used to handle multiple visual outputs. In step 5 of FIG. 1, the same visual update instructions can be sent to multiple output devices. Alternatively, different visual update instructions can be sent to multiple output devices, in which case the visual update unit preferably deals with each output device on an individual basis.

C. Providing Web Services

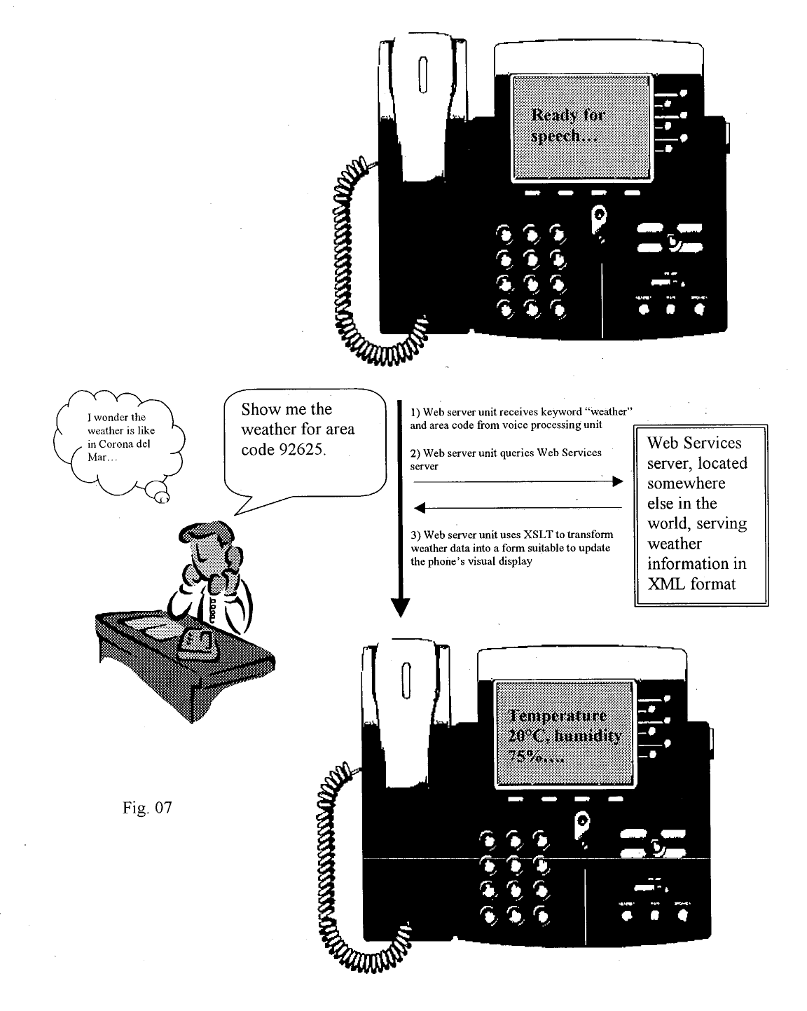

FIG. 7 illustrates an embodiment in accordance with which the invention is used to access a Web Service. Web Services, which use XML to exchange data in a standardized fashion between a multitude of client and server programs, are becoming increasingly important and prevalent. For example, they are an integral part of the Microsoft “.NET” initiative.

In one embodiment, the web server unit acts as a client for Web Services. For example, the web server can, in response to voice commands, access a Web Service and use XSLT (XML stylesheet transforms) to transform the data received into a form suitable for updating the visual display of a device.

Speech can be used to access Web Services by configuring the web server unit with a list of Web Services and XSLT transforms. The web server unit can be configured to use default processing to access Web Services for which it does not have more detailed instructions (e.g. extract only recognizable text and images from the datastream). Accordingly, the web server unit can be configured to enable access to Web Services that do not yet even exist.

D. Additional Embodiments

Input audio device: standard mobile phone (such as those made by Nokia or Motorola). Output visual device: PocketPC PDA (personal digital assistant) running Internet Explorer browser (such as those made by Compaq). The user uses the mobile phone to place a call to a Windows 2000 computer that is connected to the PSTN through a voice gateway and that is running Nuance speech recognizer and ASP NET web server. The user says, “show me headline news”; the speech recognizer recognizes the phrase and passes the token “headline_news” to the web server; the web server contacts a news Web Service and formats the result into HTML; the Internet Explorer browser on the PocketPC receives the HTML from the web server. From the user's point of view, calling a number on the mobile phone and saying “show me headline news” results in the latest news being displayed on the PDA.

Input audio device: hospital bedside phone. Output visual device: hospital bedside tablet computer (such as those made by Compaq). A doctor uses the phone to place a call to a BeVocal voice recognition server; the doctor says “radiology”; the BeVocal recognizer passes the caller's phone number and the recognized token “radiology” to an Apache Tomcat web server located in the hospital; the web server accesses the patient's medical records (it knows which patient from the phone number of the bedside phone), and the web server then sends the patient's x-ray images to the bedside tablet computer for display. From the doctor's point of view, calling a number on the bedside phone and saying “radiology” results in the patient's x-rays being displayed on the bedside tablet.

Input audio device: a Cisco 7960 voice-over-IP screen-equipped phone located in a company's sales office. Output visual device: another Cisco 7960 voice-over-IP screen-equipped phone located in the company's marketing office. Employee A in sales calls an IBM Voice Server voice recognition server and says “conference”; the IBM server calls Employee B in marketing, so that Employee A and Employee B are conferenced together via the IBM server. Since the IBM server is handling the conferencing, it receives separate audio streams from Employee A and Employee B. Employee A now says “show sales figures for December”; the IBM voice server recognizes the tokens “show”, “sales”, and “December” from Employee A's audio stream and passes those tokens, accompanied by the token “employee_b”, to the company's IBM WebSphere web server; the company web server accesses the company database, queries sales figures for December, formats the results into a XML-encoded picture of a bar graph, and sends the picture to the screen of Employee B's phone. From the point of view of Employee A and Employee B, having Employee A say “show sales figures for December” into Employee A's phone results in a bar graph of the sales figures appear on the screen of Employee B's phone.

III. Conclusion

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow.

What is claimed is:

1. A method of controlling a visual display using voice commands, the method comprising:
receiving an audio signal comprising voice commands from a user;
encoding the audio signal for transmission;
transmitting the encoded audio signal to a remote system;
in response to the transmission, receiving data from the remote system, wherein the data are configured to cause a display to display visual output; and
displaying the visual output on the visual display.

2. The method of claim 1, wherein the visual display is a display of a mobile phone and wherein the audio signal is received by the mobile phone.

3. The method of claim 2, wherein the data is received from the remote system by the mobile phone.

4. The method of claim 2, wherein the audio signal is received and encoded by the mobile phone.

5. A method of controlling a visual display using voice commands, the method comprising:
receiving a transmission of input data from a remote location, wherein the input data is based at least upon voice commands spoken by a user at the remote location;
processing the input data using automated speech recognition to identify the voice commands; and
based at least upon the identified voice commands, transmitting output data to the remote location, wherein the output data is responsive to the voice commands and wherein the output data is configured to effect output by the visual display.

6. The method of claim 5, wherein the transmission of the input data is received through a telephone system.

7. The method of claim 5, wherein the visual display is a visual display of a computer.

8. The method of claim 5, wherein the visual display is part of a video phone and wherein the transmission of the input data is received from the video phone.

9. The method of claim 5, wherein the output data comprise visual update instructions.

10. The method of claim 5, wherein the visual display is a visual display of a mobile phone and wherein the input data are transmitted by the mobile phone.

11. The method of claim 5, further comprising displaying the visual output on the visual display.

12. The method of claim 5, wherein the output data comprise HTML.

13. The method of claim 5, wherein the output data are further configured to be interpreted by the visual display.

14. The method of claim 5, wherein the output data comprise an image.

15. The method of claim 5, wherein the output data comprise text.

16. A system for controlling a visual display, the system comprising:
a sound input device configured to receive, encode and transmit sounds;
a speech processing device located remote from the sound input device, the speech processing device configured to receive and process the encoded and transmitted sounds;
a server device configured to output data based upon output received from the speech processing device; and
a visual output device located proximate the sound input device, the visual output device comprising the visual display, the visual output device configured to control the display based on output received from the server device.

17. The system of claim 16, wherein the visual display is a display of a mobile phone and wherein the sound input device is the mobile phone.

18. The system of claim 16, wherein the output received from the server device comprises HTML.

19. The system of claim 16, wherein the output received from the server device comprises an image.

20. The system of claim 16, wherein the output received from the server device comprises text.
